(19) United States
(12) Patent Application Publication
(10) Pub. No.: US 2019/0233103 A1
(43) Pub. Date: Aug. 1, 2019

(54) TEMPORARY UAV DELIVERY TOWER

(71) Applicant: Walmart Apollo, LLC, Bentonville, AR (US)

(72) Inventors: Donald R. HIGH, Noel, MO (US); Robert CANTRELL, Herndon, VA (US); Brian MCHALE, Oldham (GB)

(73) Assignee: Walmart Apollo, LLC, Bentonville, AR (US)

(21) Appl. No.: 16/259,445

(22) Filed: Jan. 28, 2019

Related U.S. Application Data
(60) Provisional application No. 62/624,686, filed on Jan. 31, 2018.

(51) Int. Cl. B64C 39/02; B64D 1/02; B64D 9/00; A47G 29/14; G06Q 10/08

(52) U.S. Cl. CPC B64C 39/024; B64D 1/02; B64C 2201/128; A47G 29/14; G06Q 10/0832; B64D 9/00

(57) ABSTRACT

A delivery tower for receiving a package from an aerial vehicle having a landing pad and a first leg pivotally coupled to a second leg. The first leg and second leg are pivotally coupled to the landing pad. The landing pad is configured to move between a first, folded position and a second, unfolded position. In the second, unfolded position, the delivery tower is configured to receive a package from the aerial vehicle.

### CROSS REFERENCE TO RELATED APPLICATIONS

This present patent application claims priority benefit from U.S. Provisional Patent Application No. 62/624,686 filed on Jan. 31, 2018, the entire content of which is hereby incorporated herein by reference.

### TECHNICAL FIELD OF THE INVENTION

The present application relates to a delivery tower for receiving a package from an aerial vehicle. More specifically, the present application relates to a temporary delivery tower for aerial vehicle package delivery.

### BACKGROUND OF THE INVENTION

Currently, delivery towers have been made for receiving packages from unmanned aerial vehicles (UAVs). UAVs may be programmed for a controlled delivery from a first controlled point (such as a warehouse or store) to a second controlled point, or delivery tower. Existing delivery towers may be sophisticated, expensive, complex, and have a large permanent footprint. Thus, existing delivery towers are not suitable for smaller delivery locations, such as homes and urban areas. Therefore, a need exists for a delivery tower which may be used in a home and may reduce the cost and footprint of existing delivery towers. A need further exists for a delivery tower which may be temporary and may be folded away when not being used to receive a package and may create greater value for customers and reduce the drawbacks of having a permanent delivery tower installed in a particular location.

### BRIEF SUMMARY OF THE INVENTION

According to an embodiment of the present disclosure, a delivery tower for receiving a package from an aerial vehicle may include a landing pad and a first leg pivotally coupled to a second leg. The first leg and second leg are pivotally coupled to the landing pad. The landing pad is configured to move between a first, folded position and a second, unfolded position. In the second, unfolded position, the delivery tower is configured to receive a package from the aerial vehicle. The delivery tower is configured to communicate with the aerial vehicle or a consumer and is further configure to automatically move between the first, folded position and the second, unfolded position after receipt of a signal from the aerial vehicle or the consumer.

According to an embodiment of the present disclosure, a method for aerial delivery of a package to a delivery location may include providing a delivery tower on a consumer's property, moving the delivery tower from a first location to a second location, the second location including an open space, unfolding the delivery tower to a first position having a landing pad of the delivery tower in a substantially horizontal position, depositing the package from an aerial vehicle onto the landing pad of the delivery tower, folding the delivery tower to a second position configured for storage, retrieving the package from the landing pad, and storing the delivery tower in the second position.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a schematic of a temporary delivery tower, according to an embodiment of the present disclosure;

FIG. 2 shows a schematic of a temporary delivery tower, according to an embodiment of the present disclosure;

FIG. 3 shows a schematic of a temporary delivery tower having a slide, according to an embodiment of the present disclosure;

FIG. 4 shows a block diagram of a delivery tower system, according to an embodiment of the present disclosure;

FIG. 5 shows a secondary operation of the delivery tower system, according to an embodiment of the present disclosure; and

FIG. 6 shows a table top sweeper rod, according to an embodiment of the present disclosure.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to delivering packages to a particular location, such as a home or store (such as a corner store, convenience store, etc.), or other location. The particular location of delivery may include a delivery tower, such as a temporary delivery tower, as will be described below. The temporary delivery tower may fold out of a wall, roof, or other structure. The temporary delivery tower may fold out as a separate structure, similar to a ladder. The temporary delivery tower may be in an unfolded position when a package is to be delivered. The temporary delivery tower may be in a folded position when a package is not being delivered and may be stored away in a roof, wall, shed, garage, basement, cellar, or other storage structure. The temporary delivery tower may have a controller and/or communications module for controlling the unfolding and folding of the temporary delivery tower and for communicating with the aerial vehicle, such as a UAV.

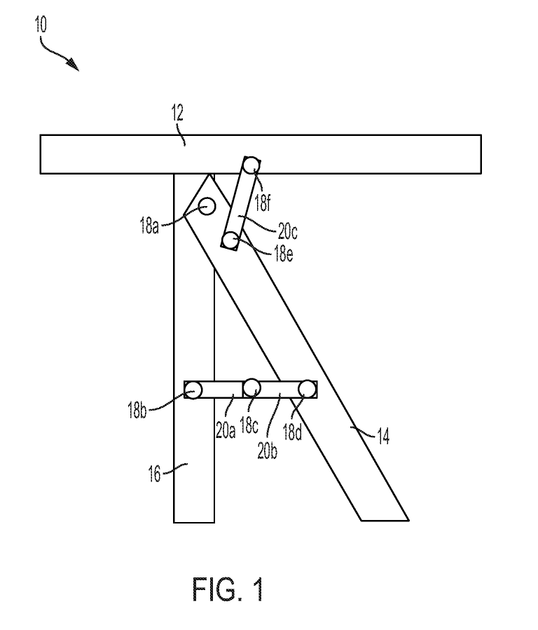

Referring to FIG. 1, a schematic view of a delivery tower 10, such as a temporary delivery tower, is shown. The delivery tower 10 may have two positions, a folded position (not depicted) and an unfolded position (FIG. 1). In the folded position, the delivery tower 10 may be folded into a tower having a smaller footprint than the unfolded position and thus may be stored easily in a garage, basement, shed, cellar, etc. The folded position may be a position where one or more legs of the delivery tower 10 are retracted, collapsed, or folded to a position that reduces the height of the delivery tower 10 and/or to a position where the one or more legs of the delivery tower 10 are substantially parallel with the surface of a landing pad of the delivery tower.

Alternatively, the delivery tower 10 may be built integrally with a building (house, shed, garage, etc.) wall or roof, or may be separately constructed and attached to the building wall or roof. In the unfolded position, the delivery tower 10 may extend outward from the building wall or roof with a horizontally, flat surface for receiving a package. In the folded position, the delivery tower 10 may fold into a position that is substantially within the profile of the wall or roof such that the delivery tower 10 does not protrude, or does not substantially protrude, from the wall or roof. The delivery tower 10 may be seamless with the roof, wall, or landscape design.

With continued reference to FIG. 1, the delivery tower 10 may include a landing pad 12. The landing pad 12 may be substantially horizontal or flat in the unfolded position depicted in FIG. 1. The delivery tower 10 may have two legs 14, 16. The legs 14, 16 may be coupled to each other with pivot points 18 and connections or linkages 20. The pivot points 18 and linkages 20 may allow for the legs 14, 16 to move between the unfolded position of FIG. 1, in which the landing pad 12 is substantially flat and a folded position (not depicted). The folded position may be a position in which the legs 14, 16 and landing pad 12 are substantially parallel with respect to one another and or a position where the legs 14, 16 reduce the height of the landing pad 12. The pivot points 18 may be one or more fasteners, pins, bolts, or other connection which allows relative rotation of the legs 14, 16 and the linkages 20. The connections or linkages 20 may be bars, links, plates, cables, or other connections that allow movement between one or more positions.

Referring again to FIG. 1, the legs 14, 16 may be coupled at an upper portion with pivot 18a. Pivot 18a may allow for the legs 14 and 16 to collapse such that they are substantially parallel to one another, either vertically or horizontally. The pivot 18a may allow for the legs 14 and 16 to reduce the height of the landing pad 12 with respect to a ground surface. The legs 14, 16 may be coupled at a lower portion with pivots 18b, 18c, 18d, and two linkages 20a, 20b. The pivots 18b and 18d may allow for the linkages 20a, 20b to move, hinging at pivot 18c, between a first position (FIG. 1) where the linkages 20a, 20b are substantially parallel and aligned with one another and a second position (not depicted) where pivot 18c is vertically above pivots 18b, 18d and where the linkages 20a, 20b are in an upside down V shape or are substantially parallel with respect to one another in a vertical position. With linkages 20a, 20b in a substantially parallel, vertical position, the legs 14, 16 may also be in a substantially parallel, vertical position. Pivots 18e, 18f and linkage 20c may allow for landing pad 12 to collapse into a position parallel and vertical with legs 14, 16. The collapsed position of landing pad 12 may be substantially perpendicular to the position depicted in FIG. 1. With the components collapsed in the parallel and vertical position, as viewed with respect to FIG. 1, the entire delivery tower 10 may be rotated and placed on a floor for storage, or may remain the vertical position for storage.

When landing pad 12 and legs 14, 16 are collapsed, the three components (12, 14, 16) may be substantially parallel with one another. In this position, the delivery tower 10 may have a slim profile, such that the delivery tower 10 may be stored in a garage, storage shed, basement, cellar, etc. The collapsing (folding) and unfolding of the delivery tower 10 may be substantially the same as a ladder. Additionally, the landing pad 12 may have a recess on the underside such that the legs 14, 16 may nest within the landing pad 12. In this embodiment, the delivery tower 10 may have a folded dimension that is no bigger than the depth of the landing pad 12, providing a small footprint for storage.

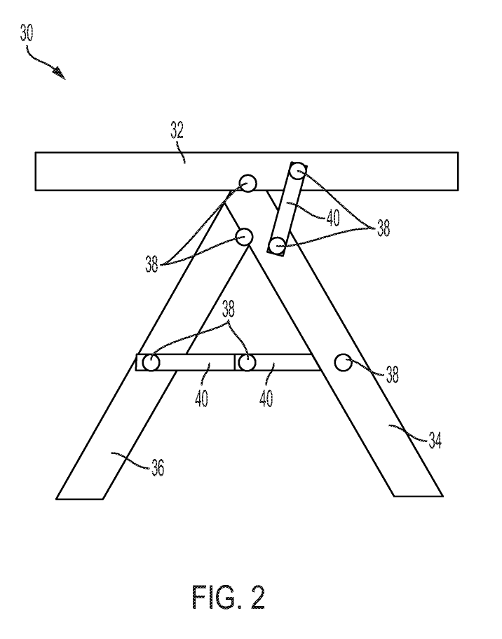

Referring now to FIG. 2, a schematic of a delivery tower 30, such as a temporary delivery tower 30, is shown. The delivery tower 30 may operate in the same or similar manner as the delivery tower 10, as previously described. The delivery tower 30 may have a landing pad 32 and legs 34, 36. The delivery tower 30 may include pivot points 38 and linkages 40. As previously described, the pivots 28 and connections or linkages 40 may allow for the delivery tower 30 to move between a folding position, where the landing pad 32 and legs 34, 36 are substantially parallel for storage, such as previously described, and an unfolded position for receiving a package, as depicted in FIG. 2. The pivot points 38 may be one or more fasteners, pins, bolts, or other connection which allows relative rotation of the legs 34, 36 and the linkages 40. The connections or linkages 40 may be bars, links, plates, cables, or other connections that allow movement between one or more positions.

Referring again to FIGS. 1 and 2, the delivery tower 10, 30 may be operated between a stored position and an operating position. The delivery tower 10, 30 may be in the folded and stored position during normal operating conditions. A consumer may place an order for a product in the conventional manner, such as by telephone, mobile device, or computer, etc. The product may be packaged and scheduled for delivery to the consumer. The package may be delivered to the consumer with an autonomous vehicle and/or an aerial vehicle, such as a UAV. When the aerial vehicle is near the delivery location, for example, within about a mile of the delivery location, the aerial vehicle may communicate with the consumer (e.g., through the mobile application, the computer, telephone, text messaging, etc.) and/or the delivery tower 10, 30 (e.g., through an onboard communications and/or controller on the delivery tower). The aerial vehicle may inform or alert the consumer and/or the delivery tower 10, 30 that the package is imminent. In the example where the aerial vehicle informs the delivery tower 10, 30, the delivery tower may in turn alert or inform the consumer that the package is imminent (e.g., through the mobile application, the computer, telephone, text messaging, etc.).

The consumer may retrieve the delivery tower 10, 30 from the storage location and unfold the delivery tower 10, 30 in a clear, open space. Alternatively, the delivery tower 10, 30 may automatically navigate to and unfold at the designated delivery location and position. The consumer and/or the delivery tower 10, 30 may then send a signal to the aerial vehicle (either via a mobile device, computer, phone, etc., or via the communications/controller on the delivery tower 10, 30) indicating that the delivery tower 10, 30 is in the unfolded position with the landing pad 12, 32 in a flat position ready for delivery of the package. The consumer, the mobile device and/or the delivery tower 10, 30 may send the location of the delivery tower (e.g. GPS coordinates or geolocation) to the aerial vehicle. Alternatively, the mobile device may send the location of the delivery tower through the GPS coordinates or geolocation of the mobile device. In this instance, the mobile device may be placed on the landing pad 12, 32 or in a designated slot of the landing pad. The designated slot may be a secured, but accessible location on the landing pad that protects the mobile device during delivery and/or landing of the aerial vehicle.

The aerial vehicle may deliver the package onto the landing pad 12, 32. Delivery of the package onto the landing pad 12, 32 may be performed in a conventional manner, such as a drop, parachute drop, cable drop, net drop, and other manners for aerial package delivery. The aerial vehicle may then communicate with the delivery tower 10, 30 or the consumer to indicate the package has been deposited on landing pad 12, 32. The consumer may then retrieve the package from the delivery tower 10, 30. After the package has been retrieved from the landing pad, the consumer may fold the delivery tower 10, 30 and/or the delivery tower 10, 30 may automatically navigate and fold into the folded position to once again store the delivery tower until the next package delivery.

As mentioned, the consumer and/or the delivery tower 10, 30 may receive a notification of impending aerial package delivery from the aerial vehicle. The notification may be a visual alert, such as a flashing of lights on the aerial vehicle or may be an e-mail notification, text messaging notification, mobile application alert, and/or mobile phone alert. When the notification is received by the consumer and/or the delivery tower 10, 30, the consumer may proceed to retrieve and unfold the delivery tower for receiving the package, as described previously. Notification of the receipt and/or completed delivery of the package may be an e-mail notification, text messaging notification, mobile application alert, and/or mobile phone alert.

Although not depicted, the delivery towers 10, 30 may further include a controller and communications module. The module may include a controller for controlling the folding and unfolding of the landing pad 12, 32 and/or the legs 14, 16, 34, 36 and/or for alerting the consumer that a package has been delivered or will be delivered soon. The controller may allow for navigation control of the delivery tower 10, 30 and control of the folding/unfolding of the delivery tower. This may allow for the delivery tower 10, 30 to operate partially or wholly autonomously. The module may include a communications device for communicating, sending, and/or receiving signals or instructions with a mobile device, such as a consumer's computer, mobile phone or mobile tablet, and/or with the aerial vehicle. The module may include both the controller and communications device or they may be provided separately. The module may provide the location of the delivery tower, verification, or a picture of the delivery tower and/or location of the delivery tower so the aerial vehicle is able to verify the delivery tower is in the proper location and position for receiving a package.

The delivery towers 10, 30 may include a clear pouch on the landing pad 12, 32. The clear pouch may house the landing pad identification and/or order identification in a QR code or other machine readable form. Accordingly, the consumer may print the landing pad identification or order identification and place the same in the clear pouch prior to receiving the package. The aerial vehicle may have sensors or cameras which may read the code ensuring delivery of the proper package to the proper delivery tower.

The delivery towers 10, 30 may be formed of aluminum or other lightweight, sturdy material that allows wind to blow through rather than over to prevent collapse of the delivery tower. The delivery towers 10, 30 may be provided with ladder like steps to allow for easy, convenient retrieval of the delivered package. Alternatively, the delivery towers 10, 30 may include a trap door drop and/or slide. After delivery of the package, the trap door may open (automatically or manually) and the package may slide to the ground and/or to a secondary delivery point for retrieval. The secondary delivery point may allow a consumer unable to climb the ladder to retrieve the package by opening the trap door and retrieving the package. The secondary delivery point may be allowed to be locked or secured ensuring safe holding of the package until the consumer is able to retrieve the package. The slide may be foldable with the delivery tower or may be a separate component which may be removed and stored separately from the delivery tower.

Although not depicted, the delivery towers 10, 30 may include a tilting device to tilt the landing pad from a generally horizontal position to an angled position. The delivery towers 10, 30 may include an extendable leaf which may extended out a side of the landing pad. The delivery towers 10, 30 may include rollers. Thus, it may be appreciated that after package delivery, the consumer may actuate the landing pad to tilt, extend the leaf, and/or actuate the rollers such that the package may slide, move, or be “poured” off of the landing pad. The consumer may actuate a manual control device and/or the actuation may be performed automatically by communications sent between the aerial vehicle and the delivery towers 10, 30 and/or between the consumer (e.g., with a mobile device) and the delivery towers 10, 30 or aerial vehicle. The tilting, extension, and rolling may facilitate the retrieval of large, heavy, and/or awkward packages which are deposited on the landing pad. The delivery towers 10, 30 may include bendable or flexible landing pad portions. The bendable or flexible landing pad portions may allow for the edges or ends of the delivery towers 10, 30 to bend such that the package may be poured or deposited onto the ground for retrieval by the consumer after delivery onto the landing pad. The delivery towers 10, 30 may have batteries, a communication system, a controller and/or light emitting diodes (LEDs) for signaling to the aerial vehicle.

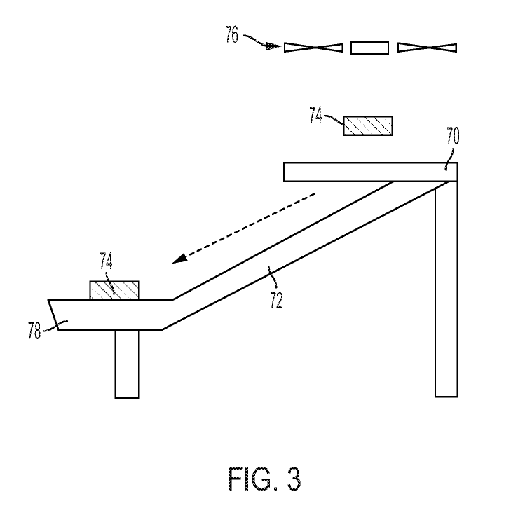

The delivery towers 10, 30 may comprise two extending leaves or may include a panel or hatch that is retractable into the landing pad. The extending leaves or retractable panel may operate similar to a hatch or retractable door. That is, the package may be delivered onto the landing pad or through an opening provided by retraction of the hatch or leaves. If delivered to the landing pad, to retrieve the package, the retractable panel or leaves may be moved laterally such that an opening in the landing pad is exposed or created. The package may fall through the opening to a secondary delivery point for retrieval. Below the opening of the hatch and/or extendible leaves may be a slide (FIG. 3), a platform, a catch net, soft surface, or other depositing platform or secondary delivery point that may receive the package. The retractable hatch or leaves may be closed after the package has been retrieved by the consumer or delivered to the secondary delivery point. As mentioned, the secondary delivery point may be allowed to be locked or secured ensuring safe holding of the package until the consumer is able to retrieve the package. The delivery towers 10, 30 may include an extendable platform which may extend through the leaves or hatch on the landing pad. During delivery of a package, the platform may extend up (e.g. via telescoping members) through the hatch, receive the package, and then retract down under the hatch. As may be appreciated, the hatch may protect the package, platform, and associated mechanics and components may be protected from the weather and/or debris and may provide a secure secondary delivery point to ensure safe holding of the package until the consumer is able to retrieve the package.

With reference to FIG. 3, the retractable hatch or leaves may open to reveal a platform 70 and slide 72. The package 74 may be released by the aerial vehicle 76 onto the landing pad (not shown). The hatch may open and the package 74 may fall or drop onto the platform 70. Alternatively, the hatch may open prior to the package 74 being release by the aerial vehicle. The package 74 may then slide down the slide 72 onto a secondary delivery point, such as second platform 78. The consumer may retrieve the package 74 from the platform 78. The slide 72 itself maybe retractable to a stored position such that it does not interfere with the delivery towers other uses. The second platform 78 may secured or locked until retrieval of the package 74 by the consumer.

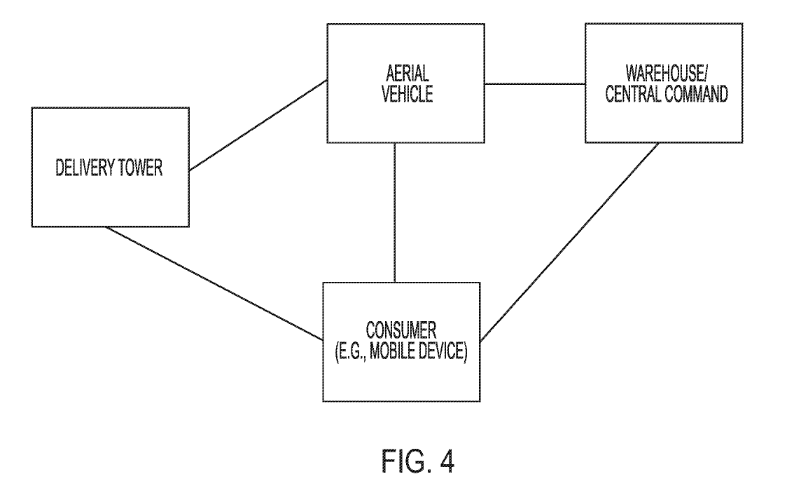

Referring to FIG. 4, a block diagram of a delivery system including one or more of the temporary delivery towers of the present disclosure is depicted. As may be appreciated, the delivery towers may communicate with the aerial vehicle to receive information on package delivery, receive instructions on deployment, receive instructions of storage, and send confirmation of package receipt. The delivery towers may further communicate with the consumer (e.g., to a consumer's mobile device) to receive information on package delivery, receive instructions on deployment, receive instructions of storage, and send confirmation of package receipt. The aerial vehicle may communicate with the consumer to send or receive information on package delivery, send or receive instructions on deployment, send or receive instructions of storage, and send or receive confirmation of package receipt. The aerial vehicle and/or the consumer may communicate with the warehouse to send or receive information on package delivery, and send or receive confirmation of package receipt.

The delivery towers 10, 30 may include a secondary delivery point or lockbox to secure the package until retrieval by the consumer. In this manner, a consumer may unfold the delivery tower 10, 30 prior to delivery and then leave the delivery area. The aerial vehicle may communicate solely with the delivery towers 10, 30 to deliver the package in the absence of the consumer. The package may be held safe in the lockbox until the package may be retrieved by the consumer, thus preventing theft or damage from weather or debris. The lockbox may be exposed in a similar manner to the previously described rollers or platform during delivery of the package. The lockbox may be fitted with a GPS tracker and/or communication device for package security.

The delivery towers 10, 30 may be standalone towers, that is, they may be individual towers unattached to another structure. Alternatively, the delivery towers 10, 30 may be built into or attached to a wall or roof of a building. In this manner, the delivery towers 10, 30 may be manually or automatically deployed to the unfolded position, resting on the ground or roof. After package delivery, the delivery towers 10, 30 may be folded into the stored position. The folded, stored position may be substantially flush with the outside wall of the building or with the roof of the building. Thus, when not in use, the delivery towers 10, 30 may have the appearance of the wall or roof of the building. The delivery towers 10, 30 may therefore be aesthetically pleasing to the consumer as they provide a hidden delivery tower for receiving packages delivered by an aerial vehicle.

In an alternative embodiment, a house retrieval box may be located in a wall or roof of a house and may fold outward to meet the aerial vehicle. The aerial vehicle may deposit or drop the package into a first opening in the house retrieval box. After the package is received, the house retrieval box may fold back into the house. The consumer may retrieve the package from a second opening in the house retrieval box which opens into the house. As such, the consumer may never have to leave the house to retrieve the package.

The delivery tower may be a star-foldup system similar to the structure of a conference exhibit booth that may be folded into a carrying case and easily deployed anywhere. Thus, if the consumer is not at home when a package is to be delivered, the consumer may direct the aerial vehicle to the current location (e.g. a beach, park, etc.) and deploy the delivery tower for receiving the package. In this manner, the consumer may receive packages when on vacation, at a park, beach, or other location.

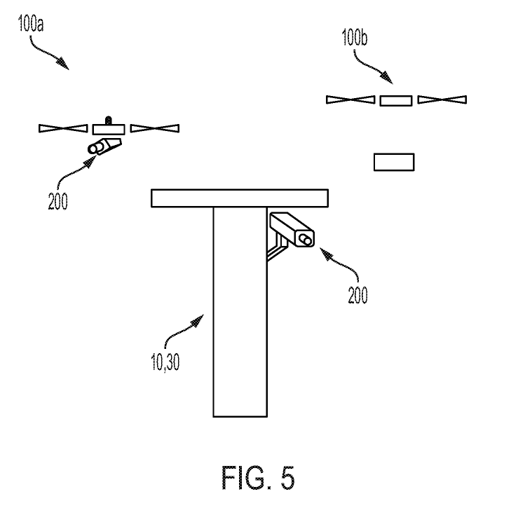

The delivery tower may have multiple roles. In an exemplary embodiment depicted in FIG. 5, the delivery tower 10, 30 and/or the aerial vehicle 100 may include security cameras 200 mounted thereon. In an exemplary embodiment, the delivery tower may be a community tower which may serve as a neighborhood watch. The community tower may have a permanent resident aerial vehicle or drone 100a. The permanent resident aerial vehicle 100a may launch from the delivery tower to serve as an autonomous neighborhood watch and patrol. When a package is to be delivered, the permanent resident aerial vehicle 100a may move to clear the tower for delivery by delivery aerial vehicle 100b and return after delivery has been completed. The delivery tower may have two-way communication and speaker system to engage with the community. The delivery tower may use proactive behavioral analytics to determine if the delivered package is under threat. When the delivery tower is a neighborhood delivery tower, one or more secondary delivery points may be included to allow for multiple consumers in the neighborhood to receive packages simultaneously or in an overlapping time frame. The secondary delivery points may be equipped with locks and individual codes to allow for security and to allow for each neighborhood consumer to have a personal delivery point.

Alternatively, the delivery tower may be provided with a UAV. The UAV may operate from the delivery tower. The UAV may be launched by the consumer to retrieve a package or product from a vendor. Accordingly, the vendor only need supply the product packaged in a standard box and the consumer supplies the UAV for retrieval of the package. The vendor may provide the package on a separate delivery tower located at the vendor location such that the UAV may retrieve and deliver the package autonomously.

The delivery tower may be provided with a recharging system. The consumer may sell back the recharging services such that the aerial vehicle lands at the delivery tower solely to recharge or to deliver a package and to recharge. Recharging aerial vehicles may clear the delivery tower to allow for package delivery. Autonomous ground vehicles may also recharge at the delivery tower.

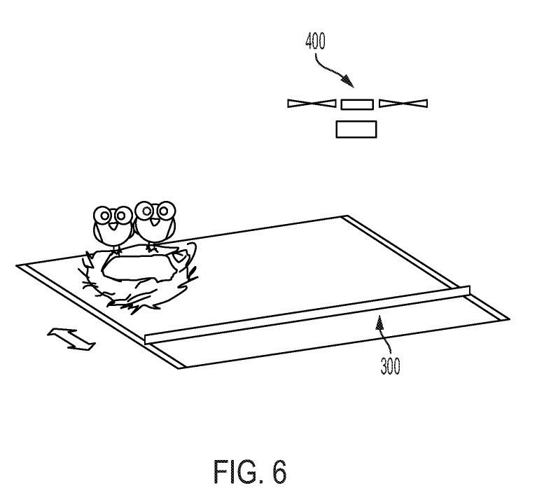

Referring to FIG. 6, the delivery tower may be provided with a tower sweeper rod 300 that clears the tower platform of debris (e.g. sticks, leaves, bird nests, etc.) prior to an aerial vehicle 400 landing or delivering a package. The tower may be fitted with a fan or blower so that debris may be removed from critical areas. Maintaining the delivery tower clear of debris may prevent damage to the delivery tower, the aerial vehicle, and the delivered package.

As may be appreciated from the foregoing disclosure, the delivery tower may allow for home UAV package delivery. The delivery tower may be simply and easily deployed, as easily as a ladder, for temporarily providing a structure on which a UAV may deliver a package. After delivery of the package, the delivery towers may be folded for storage as easily and simply as they were deployed. Unfolding and folding of the delivery towers may be performed by a single consumer without the need for additional tools and/or automatically with signals provided by the consumer's mobile device or the aerial vehicle. Thus, a low cost alternative for consumers needing occasional aerial vehicle deliveries, but who desire to not have a permanent tower in their yard. The delivery tower may be a ladder-like folding structure, as previously described. Alternatively, the delivery tower may be an attachment for the consumer's own ladder.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. A delivery tower for receiving a package from an aerial vehicle, the delivery tower comprising:
a landing pad; and
a first leg pivotally coupled to a second leg,
wherein the first leg and second leg are pivotally coupled to the landing pad, and
wherein the landing pad is configured to move between a first, folded position and a second, unfolded position, and
wherein in the second, unfolded position, the delivery tower is configured to receive a package from the aerial vehicle,
wherein the delivery tower is configured to communicate with the aerial vehicle or a consumer and is further configure to automatically move between the first, folded position and the second, unfolded position after receipt of a signal from the aerial vehicle or the consumer.

2. The delivery tower of claim 1, further comprising a plurality of pivot points and a plurality of linkages, the plurality of pivot points and plurality of linkages configured to allow movement of the landing pad, first leg, and second leg between the first, folded position and the second, unfolded position.

3. The delivery tower of claim 1, further comprising at least one of a tilting device, an extendable leaf, a plurality of rollers, a trap door, or a slide.

4. The delivery tower of claim 1, further comprising a lockbox for holding the package until retrieval by a consumer.

5. The delivery tower of claim 1, wherein in the first, folded position, the delivery tower is located flush with one of an outside building wall and a building roof.

6. The delivery tower of claim 5, wherein the delivery tower further comprises an interior opening for retrieval of the package from inside a building.

7. The delivery tower of claim 1, wherein the delivery tower is coupled to an outside building wall or a building roof.

8. The delivery tower of claim 1, further comprising at least one of a recharging station, a sweeper rod, a security camera, or a permanent resident aerial vehicle.

9. A method for aerial delivery of a package to a delivery location, the method comprising:
providing a delivery tower on a consumer's property;
moving the delivery tower from a first location to a second location, the second location including an open space;
unfolding the delivery tower to a first position having a landing pad of the delivery tower in a substantially horizontal position;
depositing the package from an aerial vehicle onto the landing pad of the delivery tower;
folding the delivery tower to a second position configured for storage;
retrieving the package from the landing pad; and
storing the delivery tower in the second position.

10. The method of claim 9, wherein unfolding the delivery tower further comprises pivoting a plurality of linkages such that the landing pad moves to the substantially horizontal position.

11. The method of claim 9, wherein the delivery tower is coupled to an outside building wall or a building roof.

12. The method of claim 11, wherein folding the delivery tower further comprises moving the delivery tower to a position substantially flush with the outside building wall or building roof.

13. The method of claim 9, wherein depositing the package further comprises lowering the package from the aerial vehicle on a rope, on a cable, with a parachute, or with a dropping device.

14. The method of claim 9, wherein retrieving the package from the landing pad includes at least one of tilting the landing pad from a horizontal position to an angled position, rolling the package on rollers, sliding the package down a slide, or extending a leaf of the landing pad.
